(19) United States
(12) Patent Application Publication
(10) Pub. No.: US 2009/0327298 A1
(43) Pub. Date: Dec. 31, 2009

(54) Multimedia journal with selective sharing, sealed entries, and legacy protection

(76) Inventors: Nick Jones, Henderson, NV (US); Adam Rogas, Henderson, NV (US)

Correspondence Address: WEIDE & MILLER, LTD., 7251 W. LAKE MEAD BLVD., SUITE 530, LAS VEGAS, NV, 89128, US

(21) Appl. No.: 12/215,585

(22) Filed: Jun. 27, 2008

(51) Int. Cl. G06F 17/30

(52) U.S. Cl. 707/9; 707/10; 707/E17.005; 707/E17.032

(57) ABSTRACT

A multimedia journal system comprising one or more journal servers and one or more client devices allows users to create an electronic journal. Journals may be redundantly stored in multiple locations so as to protect the journals from damage or destruction. The system also allows control of access to a journal or the parts thereof, and will allow a journal's owner to designate family members, friends, or others access to the journal in the event the owner passes away. Entries may be sealed to prevent or identify subsequent modifications or tampering. A sealed questionnaire is also provided, which users may answer periodically to track changes in their thoughts, feelings, or ideology. The system may be accessible via the World Wide Web.

### BACKGROUND OF THE INVENTION

1. Field of the Invention

The invention relates to an online journal system which records and stores multimedia journal entries.

2. Related Art

Keeping a journal has always been a popular activity. Traditionally, this has involved writing a daily entry recording one's thoughts or regarding an event or activity that occurred earlier. Thus, journals record the writings of their keepers for future review by the author or by others. Some journals have even been published as historically significant documents. In addition, the act of writing one's thoughts or feelings can have a therapeutic effect on the writer.

Traditionally, journals have been written journals which are typically hand written in a blank journal. Written journals are generally written on paper which may be bound together. While such journals are easy to use they must be kept nearby so that their keepers may make regular entries. Thus, written journals are commonly misplaced or lost. In addition, written journals are fragile in that there is typically only a single copy and that paper is susceptible to tearing, fire, and water. Finally, written journals offer little privacy or security and thus an author's personal thoughts may be too easily read by others.

Electronic document production methods such as word processors do allow creation of electronic documents which may be password protected and backed up. However, backups are often not made and the password protection may be easily broken by a determined third party. Keeping a journal in this manner is cumbersome as word processors were not designed for keeping a journal.

Other electronic formats include online blogs where entries are made and stored online. These blogs are created for the purpose of allowing the public at large to view them. Thus, those inclined to keep their thoughts private are not encouraged to make entries. In addition, the author does not have a personal or local copy of his or her entries on traditional blogging systems.

Thus, what is desired and disclosed herein is a multimedia journal system with selective sharing, sealed entries, and legacy protection.

### SUMMARY OF THE INVENTION

A journal system for collecting, storing, sealing, publishing, and displaying user journals is disclosed. In one embodiment, the journal system comprises one or more journal servers having one or more storage devices, at least one network interface, and one or more processors. This embodiment also includes a journal having one or more journal entries and one or more questionnaire answers stored on the one or more storage devices, and machine readable code stored on the one or more storage devices having instructions to seal the one or more journal entries and the one or more questionnaire answers. The one or more journal servers may be configured to receive the one or more journal entries and the one or more questionnaire answers from one or more client devices. It is noted that one or more copies of the journal may be published to a removable media if desired, and that copies of the journal may be stored on multiple journal servers for redundancy.

The machine readable code may seal journal entries and questionnaire answers at various times. For example, the machine readable code may seal the one or more journal entries after a 24 hour period, and the one or more questionnaire answers yearly. The machine readable code may also seal entries and questionnaire answers in various ways. In one embodiment, the machine readable code comprises instructions to seal the one or more journal entries by generating a first hash key from an input comprising at least the one or more journal entries. In another embodiment, the machine readable code comprises instructions to seal the one or more questionnaire answers by generating a first hash key from an input comprising at least the one or more questionnaire answers.

The journal system may also have machine readable code that further comprises instructions to display one or more indicators with one or more retrieved journal entries on the one or more client devices if a second hash key generated from an input comprising at least the one or more retrieved journal entries is not identical to the first hash key. The machine readable code may further comprise instructions to display one or more indicators with one or more retrieved questionnaire answers on the one or more client devices if a second hash key generated from an input comprising at least the one or more retrieved questionnaire answers is not identical to the first hash key. The one or more indicators may indicate one or more of the one or more retrieved journal entries or the one or more retrieved questionnaire answers have broken seals.

A journal user may select one or more stewards for his or her journal as well. In one embodiment, the machine readable code further comprises instructions to accept information identifying one or more journal stewards and to grant the one or more journal stewards stewardship access to the one or more journals upon the death or incapacitation of the user. In addition, the machine readable code may further comprise instructions to selectively share access to the one or more journal entries with one or more other journal accounts or one or more access accounts in some embodiments. The machine readable code may also comprise instructions to archive the journal for an archival period beginning after or upon the user's death or incapacitation.

Other information besides journal entries and questionnaire answers may be collected as well. For example, the journal may comprise one or more comments created with one or more other journal accounts or one or more access accounts and associated with at least one of the one or more journal entries. The journal may also comprise one or more afterthoughts, one or more footnotes, or both as well. The afterthoughts and footnotes may be created by the user.

In another embodiment, the journal system comprises one or more journal servers in communication with one or more client devices. The journal servers may comprise one or more storage devices, one or more processors, and at least one network interface. The one or more storage devices may be used to store machine readable code and journals comprising one or more journal entries and one or more questionnaire answers. It is noted that the one or more journal servers may receive the one or more journal entries and the one or more questionnaire answers from the one or more client devices.

The machine readable code may comprise instructions to seal the one or more journal entries by generating a entry hash key from at least the one or more journal entries after a predetermined period of time, instructions to seal the one or more questionnaire answers by generating a answer hash key from at least the one or more questionnaire answers after a predetermined period of time, and instructions to allow the one or more journal entries, the one or more questionnaire answers, or both to be selectively shared. It is noted that a hash key may be generated from additional information as well, such as a timestamp, a predetermined code, or both.

As with the above, the journal system may seal entries and questionnaire answers in various ways. For example, the instructions to seal the one or more journal entries may generate an entry hash key from at least the one or more journal entries and an entry timestamp associated therewith, and the instructions to seal the one or more questionnaire answers may generate an answer hash key from at least the one or more questionnaire answers and an answer timestamp associated therewith.

Once sealed, entries and questionnaire answers may be verified to ensure they have not been modified. Thus, in one or more embodiments, the machine readable code may further comprises instructions to retrieve a requested journal entry from the one or more journal entries, and to verify the requested journal entry by generating an entry verification hash key from at least the requested journal entry and comparing the entry verification hash key to the entry hash key. Also, instructions to retrieve a requested questionnaire answer from the one or more questionnaire answers, and to verify the requested questionnaire answer by generating an answer verification hash key from at least the requested questionnaire answer and comparing the answer verification hash key to the answer hash key may be included.

The one or more client devices may display a first indicator, indicating the requested journal entry has an intact seal, with the requested journal entry if the requested journal entry is verified. Alternatively, a second indicator may be displayed with the requested journal entry if the requested journal entry is not verified. This second indicator may indicate that the requested journal entry has a broken seal.

Similarly, the one or more client devices may display a first indicator, indicating the requested questionnaire answer has an intact seal, with the requested questionnaire answer if the requested questionnaire answer is verified. A second indicator indicating the requested questionnaire answer has a broken seal may be displayed with the requested questionnaire answer if the requested questionnaire answer is not verified.

It is noted that this embodiment may also include selective sharing, stewardship accounts, one or more comments created with one or more other journal accounts or one or more access accounts, and afterthoughts and footnotes created by the user, as well.

A method for providing a journal is also disclosed herein. In one or more embodiments, the method may comprise receiving one or more journal entries created by a user at one or more client devices. The one or more journal entries, the one or more questionnaire answers, or both may be stored on one or more storage devices attached to one or more journal servers. The one or more journal entries, the one or more questionnaire answers, or both may be sealed as well. In one embodiment, the method also comprises presenting one or more questionnaire questions and receiving one or more questionnaire answers from the user at the one or more client devices. The one or more journal entries and one or more questionnaire answers may be associated with a journal identifier which uniquely identifies a particular journal.

The method may also comprise, in one or more embodiments, selectively allowing one or more journal accounts or one or more access accounts to access to the one or more journal entries, the one or more questionnaire answers, or both. Stewards may also be provided by the method as well. For example, the method may further comprise accepting information identifying one or more journal stewards, and granting the one or more journal stewards stewardship access to the journal upon the death of the user. Other aspects of the invention may also be performed according to the method as well. In one embodiment, the method further comprises publishing the journal to removable media.

As with the above, copies of the journal may be stored on a plurality of the one or more journal servers. Also, the journal may further comprise one or more comments created with one or more journal accounts or one or more access accounts, and associated with at least one of the one or more journal entries. Finally, in some embodiments, the journal may also comprise one or more afterthoughts, one or more footnotes, or both created by the user and associated with at least one of the one or more journal entries.

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a block diagram illustrating an embodiment of the invention.

FIG. 2 is a block diagram illustrating another embodiment of the invention.

FIG. 3 is a flow diagram illustrating sealed entries according to an embodiment of the invention.

FIG. 4 is a flow diagram illustrating the display of entries according to an embodiment of the invention.

FIG. 5 is a flow diagram illustrating sealed questionnaire answers according to an embodiment of the invention.

FIG. 6 is a flow diagram illustrating the display of questionnaire answers according to an embodiment of the invention.

FIG. 7 illustrates a menu screen according to an embodiment of the invention.

FIG. 8 illustrates a new entry screen according to an embodiment of the invention.

FIG. 9 illustrates a questionnaire screen according to an embodiment of the invention.

FIG. 10 illustrates the display of a journal entry according to an embodiment of the invention.

FIG. 11 illustrates the display of questionnaire answers according to an embodiment of the invention.

### DETAILED DESCRIPTION OF THE PREFERRED EMBODIMENTS

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

As is described herein, the multimedia journal with selective sharing, sealed entries, and legacy protection is a multimedia journal system and method which allows users to create a searchable journal. Though discussed herein in terms of a journal it is noted that a diary, log, periodic record, or other records may also be created according to the invention and include the features discussed herein.

Though the invention may be used to store any information, it is specifically contemplated that the invention be used as an electronic journal to store one's opinions, beliefs, ideas, feelings, and other thoughts. The invention includes aspects, which will be described below, directed to both allowing and encouraging users to record these thoughts in various ways. For instance, the invention allows a user to selectively share their journal, or portions thereof, and allows user's to appoint stewards to their journal in the event the user dies. These features, among others, encourage users to record their thoughts honestly and openly for themselves, their descendents, or other specific people. This is in contrast with traditional electronic or online formats which focus on disseminating information to the public at large. In such formats, users may be reluctant to express their true thoughts given the public nature of these formats.

The system provides many advantages including the advantage of reliably storing a user's journal for archival such as by redundantly storing journals in multiple locations on various storage media to protect them from damage or destruction. Journals may also be protected from tampering such as by sealing entries or other information entered into the journal.

As stated, the multimedia journal system also allows control of access to the journal or the parts thereof. This protects journals and their entries against unauthorized use or access and allows the journal's owner to grant family members, friends, or others access to the journal in the event the owner passes away. In one embodiment, the system may be available on the World Wide Web and may be accessed through computer based web browsers as well as other web-enabled devices. Some embodiments of the journal may be focused on recording aspects of a user's life and thus a yearly questionnaire may be provided in one or more embodiments. Entries may be captured in various ways, such as but not limited to, file upload, text entry, SMS text message, or web-based audio or video recording. File uploads may include text, video, audio, binary, executable, multimedia files (e.g. Adobe Flash), or other files.

The multimedia journal system may be configured to collect an access fee from its users in some embodiments. For example, a monthly or other periodic payment may be collected as a prerequisite to accessing the system. In addition, a single lifetime fee may be collected in some embodiments. Once paid, the lifetime fee will generally grant access for the life of the journal's user. As will be discussed further below, additional fees may be collected as well, such as for any access accounts a user creates or for archival of the user's journal.

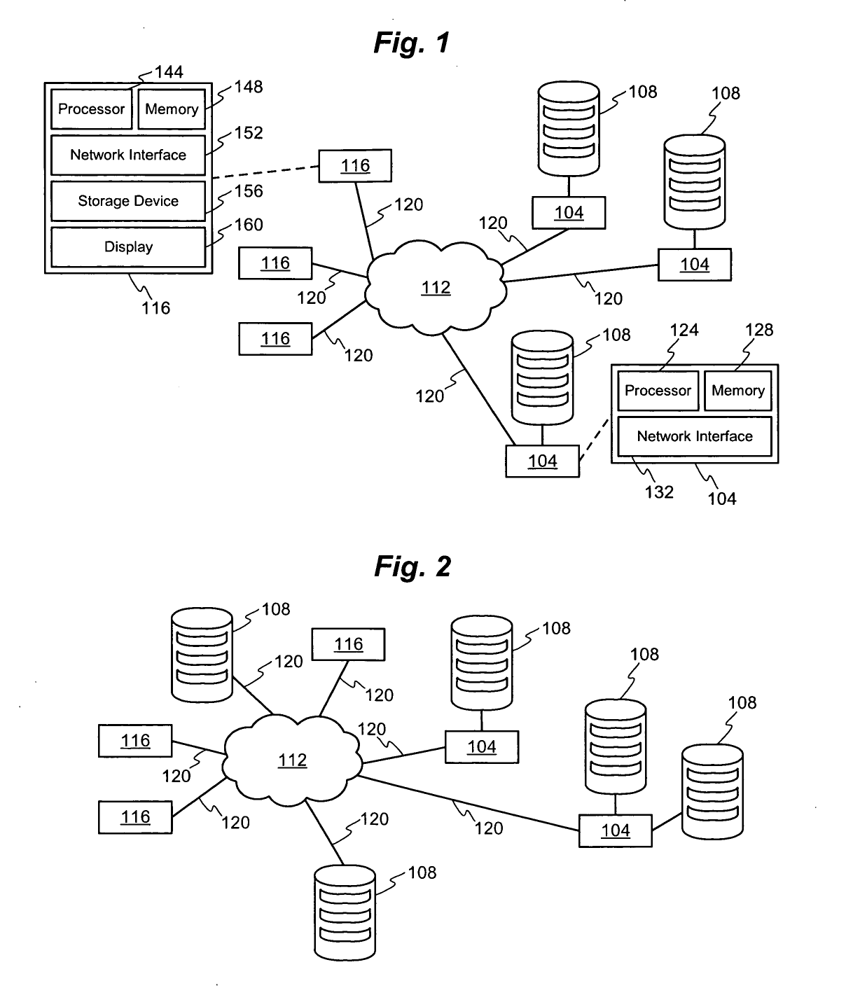

Referring to FIG. 1, the multimedia journal system comprises one or more journal servers 104 having one or more storage devices 108 in one or more embodiments. A journal may be accessed by one or more client devices 116 across various communication links 120 and networks 112.

Generally, the one or more journal servers 104 present, store, seal, and protect the journals stored on one or more storage devices 108 connected to the journal servers. In one embodiment, a journal comprises a journal identifier and all journal data associated with the journal such as but not limited to account information, user settings and preferences, payment information, access logs, stewardship accounts and information, sealed or unsealed journal entries, questionnaires and sealed or unsealed questionnaire answers, afterthoughts, comments, footnotes, or various combinations thereof. In one or more embodiments, the journal identifier is a alphanumeric or binary code or other information which uniquely identifies a particular journal and thus may be used to associate journal data with a particular journal. For example a journal entry or questionnaire answer (or any other journal data) may be associated with a particular journal by storing the entry or answer along with the journal's identifier.

Of course, not all embodiments will require a journal identifier as it is contemplated that journal data may be associated with a journal in other ways. For example, all journal data for a particular journal may be stored in a single file or directory. In addition, journal data may be stored in multiple files or directories which have been associated with a particular journal.

In one embodiment, a journal server 104 comprises one or more processors 124, one or more memory devices 128, at least one storage device 108, and at least one network interface 132. The journal server 104 may be a computer having a processor 124 such as a CPU, a memory device 128 such as RAM, a storage device 108 such as one or more hard drives, and a network interface 132 such as an Ethernet card. A computer having these elements is well known in the art and thus will not be extensively described so as to not obscure the invention herein.

It is contemplated that the journal server 104 may be any device having at least one processor 124, at least one memory device 128, storage device 108, or both, and at least one network interface 132. The processor 124 may be any processor or device capable of executing machine readable code. The machine readable code may be stored on the memory device 128, the storage device 108, or both. The memory device 128 and storage device 108 may be any storage medium or apparatus capable of storing and retrieving data. A portion or all of the memory device 128, the storage device 108, or both may be read-only in some embodiments. The network interface 132 may be any communications device capable of transmitting and receiving data. These components may be in communication through one or more electrical, optical, wireless, or other data connections.

In one embodiment, the journal server 104 is a computer configured to communicate over a local area network, a wide area network, the internet, or a combination thereof. For example, the journal server's 104 network interface 132 may be configured to communicate via TCP/IP. Of course, it is contemplated that the journal server may communicate using various wired or wireless communications protocols including packet switched and circuit switched protocols.

As stated, each journal server 104 may have one or more storage devices 108 attached thereto. Generally, a storage device 108 is used to store journals and their associated journal data. For example, journal data such as journal entries, questionnaire answers, account information, afterthoughts, footnotes, and comments may be stored on a storage device 108. In one or more embodiments, a storage device 104 comprises one or more hard drives. The hard drives may be connected in a RAID array or may simply be a plurality of drives connected to a single journal server 104. In the case of a RAID array, the drives may be configured according to any RAID level, now known or later developed. For example, a storage device 104 may be configured for RAID 0, RAID 1, or RAID 5. It is noted that a storage device 104 may be a solid stated drive or a flash drive. In addition, a storage device 104 may be an optical drive in some embodiments.

One advantage of the multimedia journal system is that journal data may be redundantly stored on more than one journal server 104 and the journal servers may be spread across vast geographic areas. Thus, damage or destruction of one journal server 104 does not damage or destroy a journal or the ability to access it. For example, a journal may be stored and accessed on one or more journal servers 104 in one location during loss of network connectivity to one or more servers at another location. Thus, journals may be reliably stored for very long periods of time.

It is contemplated that additional journal servers 104 may be connected to the multimedia journal system at any time, and that once connected, existing journal data may be copied to and accessed from these additional journal servers. Changes, additions, and deletions to a journal made at a particular journal server 104 may be communicated to other journal servers so that every journal server has an up to date copy of the journal.

Another advantage of the multimedia journal system is that access to journal data may be encrypted to prevent unauthorized access. In one embodiment, the journal data is encrypted by the journal server 104 before it is stored. In this manner, only those with proper passwords or other authentication data may access the journal data. It is contemplated that, with encryption, unauthorized access may be prevented even where an unauthorized party has physical access to the storage device upon which the journal data is stored. In addition, in some embodiments, the journal system may be configured such that even administrators or other personnel of the journal system cannot access a user's journal data because it has been encrypted. This functionality may be implemented by a public key infrastructure or other encryption system, now known or later developed.

As will be described further below, a journal server 104 may execute machine readable code to provide the functionality of the multimedia journal system. For example, the journal server 104 may execute machine readable code such as web server software, database software, or both to generate the pages or screens of a journal for display on one or more client devices 116. The web server may communicate with the database software to store and retrieve journal entries, account information, user preferences, and other information associated with a journal.

The multimedia journal system also includes one or more client devices 116 in one or more embodiments. Generally, a client device 116 allows a user or others to view, add to, modify and otherwise interact with a journal. For example, a user may read or enter journal entries or answer questionnaires as well as change user preferences, passwords, and other user preferences from a client device 116. It is contemplated that other journal data may be created, edited, or deleted via one or more client devices 116 as well.

In one embodiment, a client device 116 comprises one or more processors 144, one or more memory devices 148, at least one network interface 152, one or more storage devices 156, and at least one display 160. It is noted that the processor 144, the memory device 148, and the network interface 152 may be the same as corresponding elements of the journal server 104. A client device 116 may be a computer such as a personal computer having a processor 144 such as a CPU, a memory device such as RAM, a storage device such as a hard drive, a network interface such as an Ethernet card, and a display such as a monitor. A computer is well known in the art and thus will not be extensively discussed herein so as to not obscure the invention.

It is contemplated that a client device 116 may be any device, now known or later developed, capable of accessing a journal or journal data from a journal server, displaying a journal or portions thereof, and collecting journal data and other input. For example, a client device 116 may be a PDA, laptop, smart phone, or any web enabled device. The processor 144 may be any processor or device capable of executing machine readable code. The machine readable code may be stored on the memory device 148, a storage device 156, or both. It is contemplated that a client device 116 may execute machine readable code such as a web browser to access the journal from one or more journal servers 104.

The memory device 148 and storage device 156 may be any storage medium or apparatus capable of storing and retrieving data. A portion or all of the memory device 148, the storage device 156, or both may be read-only in some embodiments. The network interface 152 may be any communications device capable of transmitting and receiving data. These components may be in communication through one or more electrical, optical, wireless, or other data connections.

In one embodiment, the client device 116 is a computer configured to communicate over a local area network, a wide area network, the internet, or a combination thereof. For example, the client device's 116 network interface 152 may be configured to communicate via TCP/IP. Of course, it is contemplated that a client device 116 may communicate using various wired or wireless communications protocols including packet switched and circuit switched protocols.

Each client device 116 may have one or more storage devices 156. The storage device 156 may be used to store journal data which comprises the entries and other information related to one or more journals. In one or more embodiments, a storage device 156 comprises one or more hard drives. It is contemplated that a storage device 156 may be a flash drive, solid state drive, or an optical drive in one or more embodiments. The hard drives may be connected in a RAID array or may simply be a plurality of drives connected to a single client device 116. In the case of a RAID array, the drives may be configured according to any RAID level, now known or later developed. For example, a storage device 156 may be configured for RAID 0, RAID 1, or RAID 5.

One advantage of a storage device 156 in the client device 116 is that a copy of a journal may be locally stored on the client device 116 so that the journal may be accessed on the client device 116 without a connection to a journal server 104. In addition, this local copy increases the number of redundant copies of the journal and thus further increases the multimedia journal systems reliability. In this way, a journal may be stored and directly accessed on one or more client machines,

It is contemplated that a copy of the journal may be published to removable media such as but not limited to magnetic media, optical media, flash media, paper as well as other removable media now known and later developed. In one or more embodiments, publishing in this manner occurs by storing a copy of the journal on removable media. Once stored on removable media, the journal may be safely kept such as in an archive, safe deposit box, safe, or other container for later retrieval. It is contemplated that copies of journals on removable media may be copied back to one or more journal servers 104 in the unlikely event that every copy on a journal server is damaged or destroyed. It is contemplated that copies stored on some removable media may include machine readable code to view the journal on any client device. For example, a copy of a journal on magnetic, optical, or flash media may include viewing software that allows a user to easily view the journal once the copy has been inserted or inputted into a client device.

As stated, a copy of a journal may be published to paper as well. For example, a user may print a copy of the journal from printer attached to a client device. A user may also order a printed copy of his or her journal. For example, a user may order a bound copy of his or her journal. Such a copy may utilize archival paper designed to last many years. In one or more embodiments, a fee may be charged for printed copies of journals which are ordered.

It is contemplated that the user may choose which entries or other aspects of his or her journal are published to removable media. For example, the user may select to publish a copy of his or her journal with or without any third party comments, or with or without afterthoughts, footnotes, yearly questionnaires, or a combination thereof. The user may select individual entries, comments, afterthoughts, footnotes, and yearly questionnaire questions and answers to publish in one or more embodiments.

In one or more embodiments, the multimedia journal system may present one or more screens to the user which allow the user to select which portions of his or her journal the user wishes to copy to removable media or print. For example, the user may be presented a screen listing parts of a journal such as entries, comments, afterthoughts, footnotes, sealed yearly questionnaires, or a combination thereof. The user may then select which of these parts he or she wishes to publish. In one or more embodiments, the user may be allowed to organize parts of his or her journal such as by placing entries or other elements of the journal in a certain order or by organizing the visual layout of his or her journal. It is contemplated that the system may present a preview of the journal to be published according to the user's selections to ensure that the publication will be as the user desires. For example, the system may provide a WYSIWYG display of the journal to be published. The system may also allow the user to interactively organize and select portions of the journal to copy or print. For example the user may be allowed to drag and drop and add and remove portions of the journal as they are to appear on the copy or printout.

As shown in FIG. 1, the client devices 116 and journal servers 104 communicate through one or more communication links 120 connected to a network 112. The client devices 116 and journal servers 104 may be connected to one or more communication links 120 through one or more network interfaces 152,132. Generally, each communication link 120 is a data connection between the client device 116 or journal server 104 and its nearest network device such as a switch or a router. This communication link 120 connects to a network 112 allowing data to be communicated therethrough. It is noted that there may be more than one network 112 and that each client device 116 or journal server 104 may have multiple communication links 120 for increased reliability or to increase bandwidth.

The communication links 120 may be various wired and wireless links, now known or later developed, including various optical and cellular based links. In one or more embodiments, communication through the communication links 120 and the one or more networks 112 occurs via IP. It is contemplated that other protocols capable of communicating data between a client device 116 and a journal server 104, now known and later developed, may be used including wired, wireless, circuit switched, and packet switched protocols.

In one embodiment, one or more client devices 116 and one or more journal servers 104 communicate across the internet. In this way, journal servers 104 may be located throughout the globe and may be accessed by any client device 116 having Internet access. Advantages of communicating across the internet include its robust and inherently reliable packet switched network, the fact that access to the internet is available virtually anywhere, and that worldwide communication may be achieved at low cost through the internet.

FIG. 2 illustrates the variability of the possible configurations for the multimedia journal system. For example, FIG. 2 illustrates a journal server 104 having multiple storage devices 108. It is noted that each storage device 108 may comprise one or more individual hard drives (or other magnetic, optical, or solid state drives) such as in a RAID configuration. Multiple storage devices 108 may be used to increase redundancy or the storage capacity of an individual journal server 104.

FIG. 2 also illustrates storage devices 108 connected to one or more journal servers 104 through a network 112. For example, a storage device 108 may be connected via a storage area network (SAN), or a storage device may be network attached storage (NAS). In this manner, a storage device 108 may be located at a different geographic location than both a journal server 104 and other storage devices 108 connected to the journal server 104. It is contemplated that multiple journal servers 104 may store and retrieve data on a storage device 108 connected to the journal servers 104 through one or more networks.

In one or more embodiments, users may be required to sign up for a journal account before they may access the multimedia journal system. Generally, the journal account is associated with at least one journal and the holder (i.e. user) of the journal account will be the owner of the associated journal. This may occur by the journal account including information uniquely identifying one or more journals, such as the journal identifier described above. During sign up, a journal server 104 may collect user information such as but not limited to names, addresses, email addresses, phone numbers, usemames, passwords, birthdates, education information, employment information, or religious information. In addition, payment information such as account numbers or credit card information may be collected for embodiments of the journal system which require users to pay to use the system. It is noted that such signups are known in the art and that any signup system or method, now know or later developed, may be used with the invention herein.

Once a journal account has been created, a user must login to access his or her journal in one or more embodiments. This may be accomplished by the user entering a usemame and password associated with his or her journal account. Of course other methods of user authentication, now known or later developed, may be used such as biometrics (e.g. fingerprint, palm, iris, facial, or voice recognition), hardware access keys (e.g. USB access keys or hardware encryption keys). The user may be asked one or more questions of which it is likely that only the proper user would know the correct answer to authenticate his or her identity as well.

As stated, the multimedia journal system allows users to selectively share their journals or the portions thereof. Selective sharing allows a user to grant or deny certain access privileges to his or her journal or the portions thereof. Access privileges may include read (e.g. ability to view) and write access (e.g. ability to comment). For example, the system may allow a user to selectively share a journal with other people having journal accounts, access accounts, and steward accounts, as will be described further below, by granting or denying access privileges to these accounts. Of course, the journal or portions thereof may be made accessible to the public and thus it is contemplated that a user may allow anyone to access his or her journal without a username or password if desired. It is noted that selective sharing is capable of allowing other people to delete portions of the user's journal however, this capability will typically not be used.

In one or more embodiments, selective sharing allows a user to select other journal accounts that may access the user's journal or specific parts of the user's journal. In addition, a user may create access accounts for people who do not currently have an account on the multimedia journal system. It is noted that an access account generally differs from a journal account in that an access account does not allow its holder to create his or her own journal. Instead, an access account allows a person to access the journal, or portions thereof, belonging to another person.

In one or more embodiments, a user may create an access account by entering at least a username and password and assigning one or more access privileges (e.g. read only or comment privileges). Other identifying information such as the person's name, address, email, or other information may be entered as well in some embodiments. The user may then give the username and password to a person the user wishes to have access to the user's journal. The system may be configured to forward the username and password to the person as well such as by email, regular mail, text message, or other notification system. Once a valid username and password has been received, this person may read and comment on the user's journal according to the person's assigned access privileges. It is noted that steward accounts may be created similarly as will be described further below.

One advantage of selective sharing is that selective sharing allows a journal to be shared in a wide variety of ways. For example, a user may specify that Person A may only read the user's entries while Person B may read and comment on or otherwise add to the user's entries. The user may identify specific entries that may be read or commented on by others in some embodiments. For example, the system may present the user with a list of some or all journal entries. The user may then select any or all of the entries and select one or more people that will be allowed to read or comment on the selected entries. It is noted that the user may also selectively share other parts of the user's journal in this manner as well, such as but not limited to the user's afterthoughts, footnotes, and sealed yearly questionnaire which are discussed further below.

It is contemplated that selective sharing may allow accounts to be grouped and that each group may be allowed to read or add to a user's journal or portions thereof. For example, a user may create a family group and a friends group and assign various accounts thereto such as journal, access, steward accounts. In this manner, accounts in the family group may be given different access privileges than users in the friends group (or any other group). Groups may be created and accounts may be assigned to groups as desired by the user.

A user may make his or her selective sharing selections during account sign up or at anytime thereafter. Selective sharing may be accomplished in one or more embodiments by the multimedia journal system presenting a list of journal or other accounts on the system to the user so that the user may select one or more existing users for selective sharing. It is contemplated that during or after the selection of one or more accounts for selective sharing, the system may allow the user to change access privileges as well.

In one or more embodiments, journal accounts may be suspended if desired. For example, a user that has been called away for military duty, missionary service, the Peace Corps, or other reasons may suspend his or her account. This is advantageous in that the user will not be charged for access to the multimedia journal system during the time his or her account is suspended. It is contemplated that a user may not indefinitely suspend his or her account in some embodiments.

The ability to selectively share a journal also allows a user to designate stewardship of his or her journal in the event the user's passing or death. This is referred to herein as legacy protection because the journal may be archived and passed on to the user's descendants, friends, or other people. In this manner, the user's recorded entries, thoughts, and feelings may be preserved for the future.

A user may designate a steward for his or her journal in a number of ways. For example, a steward may be designated such as by picking a user from a list of existing journal accounts or access accounts presented to the user on a client device. It is noted that multiple people may be selected to be stewards for a particular journal and that in some embodiments a user may designate a steward to access only a portion of his or her entire journal if desired.

In addition, a user may create one or more steward accounts designating one or more people as stewards if desired. The steward accounts may be created in any method now known or later developed such as the methods described above regarding the creation of access or journal accounts. A steward may receive stewardship to a journal by the multimedia journal system granting access to the steward after a journal owner's death. For example, the system may send an access code, username and password, hardware key, or other authentication information or device to a steward.

In addition, if the steward has a journal or access account, the system may grant the steward's journal or access account stewardship. In this manner, the steward may use his or her journal or access account's username and password and the multimedia journal system would not have to forward any authentication information to the steward. It is contemplated that the system may be configured to notify steward, journal, and access account holders of their stewardship privileges after the user's passing. Notification may occur in various ways such as but not limited to email, regular mail, text message, or telephone.

It is contemplated that a steward may receive stewardship of a journal for events other than death. For example, stewardship may be granted when a user is incapacitated such as by physical or mental illness or injury. Such incapacity may be defined through one or more criteria or medical or other diagnosis agreed to by the user prior to his or her incapacitation if desired. Various ways of informing the journal system that a user is incapacitated may be used such as messages from doctors, guardians, and the like which are not extensively described herein so as to not obscure the invention.

In one or more embodiments, journal accounts and access accounts without stewardship privileges may be suspended or denied access to a journal whose owner has died or become incapacitated. In these embodiments, only stewards may access a journal whose user has died or become incapacitated. Stewards may be granted stewardship access which may allow the stewards to read, download, and print the journal. In addition, stewardship access may include the ability to order hard copies or electronic copies of the journal published on removable media.

It is contemplated that stewardship access may be limited to a period of time. For example, in one embodiment, the steward would be granted access for 90 days upon being granted stewardship. During this period, the steward would be able to read, download, and print the journal for free. The steward may be charged a fee to access the journal after 90 days. Of course, other embodiments may utilize different time periods greater or less than 90 days. It is noted that a steward may access the journal at any time during the archival period of a journal.

Generally, the archival period of a journal is the period of time after the journal user's passing or incapacitation where the journal will be stored on one or more journal servers of the multimedia journal system. Of course, archival period may be any period desired. In one embodiment, the archival period is fixed at 7 years for all journals, but may be extended by the user paying a fee to extend the period or by one or more stewards paying the fee to extend the period.

The archival period may be selected by a user or by a steward after the user's passing. For example, in embodiments where the user must pay a fee to use the multimedia journal system, the user may pay the fee associated with an archival period of a certain duration. It is contemplated that higher fees may be required for longer archival periods. In some embodiments, a portion of the user's periodic access fee may be allocated to pay for an archival period at a fixed rate. For example, a portion of a user's monthly access fee may be collected and saved to pay a yearly archival fee after the user's passing. Of course, other ways of paying for archival may be used in embodiments of the system which collect fees.

As stated, entries may be collected by the multimedia journal system in various ways. The entries themselves may include but are not limited to text, pictures, audio, video, other multimedia file formats (e.g. Adobe Flash), HTML, WWW links, XML, animations, references to printed publications, biblical or historical references, or a combination thereof. In one or more embodiments, users make entries on a client device 116. For example, a journal entry screen may be generated by the journal server 104 and displayed on the client device 116. The user may then make an entry by inputting text, uploading files, recording a video or audio entry, or providing other input to the journal server 104 through a client device 116. In a web based embodiment, the journal entry screen may be a web page with one or more text input, file upload forms, video or audio recording controls, or a combination thereof.

In some embodiments, the multimedia journal system may present one or more entry screens including one or more lists from which a user may pick one or more items. For example, biblical references, historical references, references to publications (e.g. printed and electronic publications), or a combination thereof may be presented in a list allowing a user to select one or more relevant references to his or her journal entry. It is contemplated that the journal entry screen may also capture other user input such as by recording audio or video, or allowing a user to draw via a mouse or other input device on the screen.

Once an entry has been made, the user may send the entry to the journal server 104. This may occur by the user activating or clicking a button or link such as a send or save button on the screen. It is contemplated that the client device 116 may be configured to automatically send entries to the journal server 104 after or during their creation without user intervention in some embodiments.

As stated, entries may be sealed on the journal server 104 in one or more embodiments. Generally, sealing an entry allows the journal server 104 to verify that an entry has not been modified after it has been sealed. In addition, the time the entry was made may be verified.

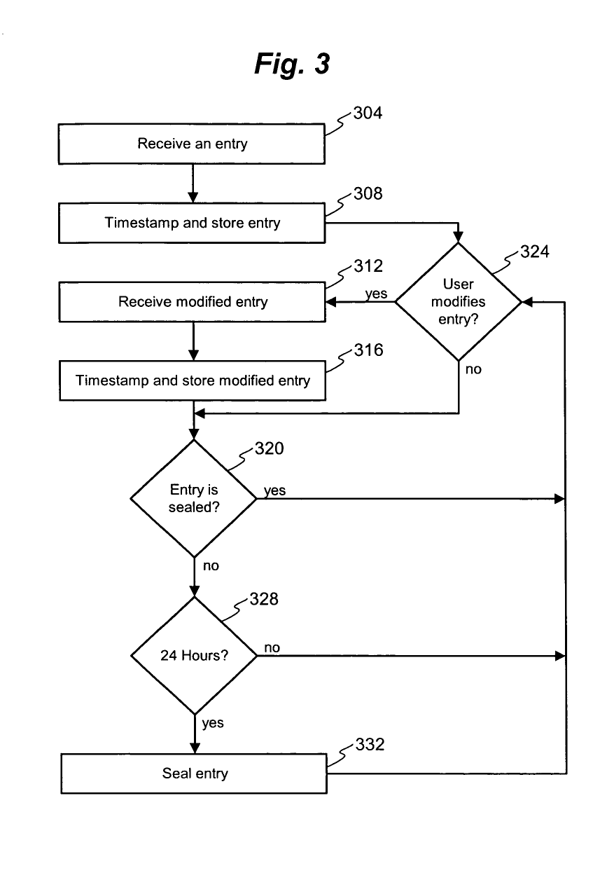

FIG. 3 is a flow diagram illustrating how an entry may be sealed according to an embodiment of the invention. Though sealed entries are described below referring to a journal server, it is noted that because journals may be saved locally on a client device some client devices may be configured to seal entries as well. At a step 304, a journal server receives a journal entry. In one or more embodiments, the entry will be transmitted from a client device to the journal server as described above. Once an entry has been received, the entry may be timestamped and stored at a step 308.

An entry may be timestamped in various ways. In one embodiment, the journal server may record the date and time an entry was received as the timestamp. In another embodiment, the client device may send a timestamp indicating the time the entry was completed to the journal server. The client device, the journal server, or both may be synchronized to one or more time servers or other timing devices and may create timestamps with resolutions down to the millisecond or better. Regardless of how an entry is timestamped, the entry's timestamp may be stored along with the entry or otherwise associated with the entry such that each entry's timestamp may be retrieved along with the entry. It is noted that timestamping is not required and thus may not occur in some embodiments.

In one or more embodiments, entries may be stored by one or more journal servers. For example, an entry may be received by a journal server through its network interface and subsequently stored on the journal server's storage device. Once received or stored by the journal server, the journal server may send the entry to other journal servers so that redundant copies may be made or so that copies of a journal on another server may be updated. Redundant copies may be made by copying an entire journal to one or more other journal servers. However, it is contemplated that data synchronization algorithms such as rsync or database synchronization routines may be used to make redundant copies with lower bandwidth requirements.

As stated, a local copy of the entry may be stored on the client device in some embodiments. In this manner a redundant copy of the entry or an entire journal may be kept on the client device. This is advantageous in that the local copy may be accessed where there is no connection to a journal server.

The user may modify previously made entries in one or more embodiments. This may occur by the user accessing a previously stored entry and adding to or deleting from the entry. The ability for a user to modify an entry is represented by a decision step 324. If the user does modify the entry, the sealed entry process proceeds to step 312 where the modified entry is received and then to step 316 where the modified entry is timestamped and stored as described above with regard to step 308.

It is contemplated that in some embodiments, an original entry and all modifications thereto may be recorded so that the original entry and every modification of it may be later viewed. For example, the original entry and subsequent modifications may be stored as separate records in a database. However, other embodiments may be configured to only store entries in their current form. In this manner, the history of modifications for a particular entry is discarded and only the entry in its latest form is stored.

While keeping a record of modifications provides a more detailed record of an entry, users may not want the portions of an entry they delete or change to be kept. This may be especially so in a journal. Thus, a record of modifications may not be stored in some embodiments. Of course, some users may desire a record of modifications and thus it is contemplated that the multimedia journal system may be configured to store only the latest form of an entry or to keep a record of modifications.

Regardless of whether a record of modifications is stored, entries may be sealed after their initial creation in one or more embodiments. Generally, an entry may be sealed by generating a hash key using at least the entry as input to the hashing algorithm. The entry's timestamp may also be inputted into the hashing algorithm if desired. It is noted that any hashing algorithm, now known or later developed, such as MD5 and SHA1, may be used to generate the hash key. A predetermined code or other input may be inputted along with the entry, timestamp, or both as a way of verifying the hash key has been generated by the multimedia journal system and preventing forged hash keys.

The generated hash key may be a string of ASCII characters or binary data and may be stored along with its associated entry in one or more embodiments. For example, the hash key may be stored in the same row as it associated entry in a database table. In some embodiments, the hash key may also be associated to an entry storing the hash key along with information that uniquely identifies its associated entry. The hash key may be used to both seal an entry and, as will be described below, may be used to verify that the entry, its timestamp, or both has not been modified after it has been sealed. In addition, the hash key may be used to seal and verify other information besides entries, such as questionnaire answers, as will also be described below.

At a decision step 320 it is determined whether the entry has ever been sealed before. This may occur by the journal server 104 checking whether or not a hash key has been associated with the entry. If no hash key has been associated with the entry, then the entry may be considered unsealed in one or more embodiments.

If the entry has been sealed, the multimedia journal system may proceed back to step 324 to await further modifications of the entry. Thus, an entry may be modified after it has been sealed, however, in one or more embodiments, modifying an entry after it has been sealed will break its seal as will be described further below. Of course, it is contemplated that in some embodiments, modifications to sealed entries will not be permitted. For example, a sealed entry may be displayed in read only form without a control or screen element for user input.

If the entry has not been sealed, the multimedia journal system may proceed to a decision step 328 where it is determined whether 24 hours have passed since the entry was originally stored by a journal server or created by the user. If 24 hours have not passed then the entry is not sealed and the system may return to decision step 324 to await further modifications by a user, if any. If 24 hours have passed then the entry may be sealed at a step 332 by generating an entry hash key as described above and storing the hash key such that it is associated with the entry. Of course, any predetermined time period or a specific date, time, or both may be used instead of a 24 hour period.

The time period before an entry is sealed is advantageous in that it allows a user to modify an entry without breaking its seal. A user may think of additions, deletions, or modifications soon after an entry has been made and this time period allows time for these changes to occur by delaying the sealing of the entry. However, it is contemplated that in some embodiments entries may be immediately sealed once they have been made (e.g. when the entry is stored) to permanently record the user's entries at the time they were made. This may be advantageous in that the user's actual thoughts and feelings at the time of the entry is stored and cannot be edited, censored, or otherwise changed after the fact. In one or more embodiments, the user may be given a choice as to when his or her entries may be sealed via one or more preferences screens generated by the system.

As stated, in one or more embodiments, a user may modify an entry after it has been sealed. Thus, the multimedia journal system may return to decision step 324 to await further modifications of an entry after it has been sealed at step 332. Of course, some embodiments may not allow further modifications to a sealed entry as described above.

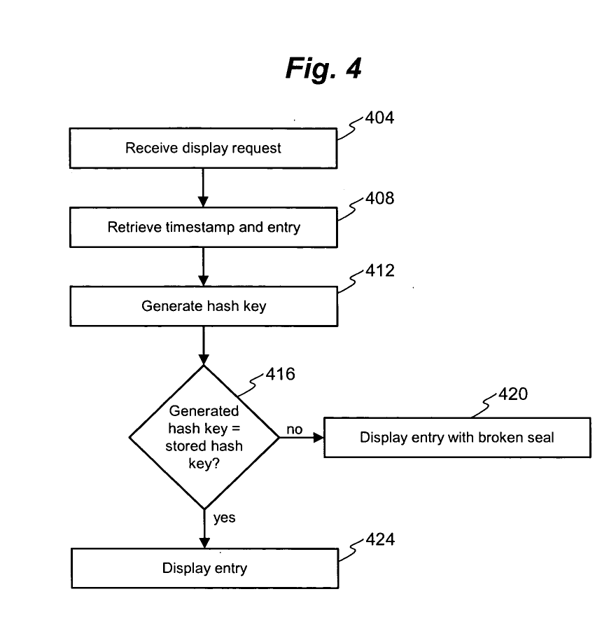

Generally, modifying an entry after it has been sealed will break its seal. Such an entry may be displayed with an indicator indicating the entry has a broken seal. For example, the indicator may be text, audio, video, animation, or an image indicating to users or others that the entry has been modified. In one embodiment, an image comprising a broken seal may be displayed. A timestamp of the modification may also be provided. FIG. 4 illustrates the display of an entry and how this may be implemented in one or more embodiments.

At a step 404 the multimedia journal system receives an entry display request. In one or more embodiments, this may occur by a client device requesting an entry from a journal server. The request may be transmitted from the client device's network interface and may include information identifying one or more entries to be displayed. For example, each entry may have a unique identifier, such as an index field in a database, and the client device may request entries according to their unique identifiers. In addition, the client device may issue a display request for every entry in a journal.

If the request properly identifies one or more entries, the identified entries are retrieved by the journal storage at a step 408 by reading the identified entries from a storage device or a memory device. It is contemplated that an error message or code may be returned to the client device if the journal server cannot locate a requested entry. Also, the timestamp associated with each entry may be retrieved in the same manner as well at step 408.

At a step 412, the entry or entries retrieved at step 408 may be inputted into a hashing algorithm, such as described above, to generate an entry verification hash key. If a timestamp, predetermined code, or both were included as an input to generate the entry hash key when a particular entry was sealed, the timestamp, predetermined code, or both may be accordingly included as an input to generate the entry verification hash key at step 412.

At a decision step 416 the entry verification hash key generated at step 412 may be compared to the entry hash key generated to seal the entry. If both hash keys are identical then the entry (and its timestamp in some embodiments) has not been modified since they were sealed and the entry may be displayed at a step 424. In this case the entry may be displayed with an indicator showing the entry's seal is intact such as with a graphic of an intact seal. Of course, the entry may simply be displayed without an indicator as well.

If the hash keys are not identical then the entry, timestamp, or both have been modified since they were sealed. In this case the entry may be displayed at a step 420 with an indication that its seal has been broken such as described above. For example, the entry may be displayed in a color distinct from entries with intact seals, or a graphic of a broken seal may be displayed along with the entry.

In either case, display of an entry may occur on a screen or other output device of the client device. In one embodiment, the journal server transmits the entry and information indicating whether the entry's seal has been broken to the client device which accordingly displays the entry or displays the entry with an indication that its seal is broken.

As stated above, the multimedia journal system allows comments, afterthoughts and footnotes to journal entries. Comments are generally made by people other than the user, such as other journal account holders or access account holders, in response to the user's entries, afterthoughts, or footnotes, as well as other comments. It is contemplated that a person may choose which entry or comment he or she wishes to comment in one or more embodiments. As stated above with regard to selective sharing, the user may restrict the ability to comment on entries to specific users, specific entries, or a combination thereof.

The user also may be provided the ability to enter afterthoughts. Generally, an afterthought is text or other typed, drawn, or written information related to a journal entry after the journal entry's creation, and may be created, modified, and removed independent of the entry itself. This is advantageous in that the user may include additional thoughts on an entry as an afterthought even after the entry is sealed. Thus, for example, after having time to reflect a user may add an afterthought to his or her entry without causing the seal of the entry to be broken. The afterthought may be removed without breaking the seal as well. Of course, if the user has new thoughts or wishes to change an entry before it has been sealed, the user may directly edit the entry as well without breaking the entry's seal.

The user may also enter footnotes to entries. Footnotes may also be created, modified, and removed independent of an entry and thus also do not break the seal of a sealed entry when they are created, modified, or removed. Generally, a footnote is a file, link, or reference associated with a journal entry. For example, a footnote may be an image file, video or audio file, web link or URL, reference to a publication, a historical reference, or a biblical reference. The multimedia journal system may present one or more lists from which a user may pick one or more items to create a footnote. For example, biblical references, historical references, references to publications (e.g. printed and electronic publications), or a combination thereof may be presented in a list so that a user may select one or more references to be a footnote. Of course, users may input their own files, links, and references as well.

In one or more embodiments, entries, comments, afterthoughts, and footnotes may be collected by the system allowing input of text, audio, video, images, or other information through a client device. This may be accomplished by presenting an input screen or box in one or more embodiments. It is contemplated that information such as video, audio, writing, or drawings may be directly recorded by the system as well. Comments, afterthoughts, and footnotes may be selectively shared by the user and be protected by legacy protection in one or more embodiments. In one or more embodiments, comments, afterthoughts, and footnotes may be associated with one or more entries by storing them with information uniquely identifying their associated entry.

As stated, one aspect of the multimedia journal system is a sealed yearly questionnaire that a user may use to record his or her thoughts, opinions, and ideas with regard to a set of questions presented to the user every year. In this manner, the changes in the user's thoughts, opinions, and ideas may be revealed giving the user some perspective on his or her life. It is contemplated that in one or more embodiments, the same questions will be presented to the user each year. Of course, questions may be added, removed, or modified in some embodiments, if desired.

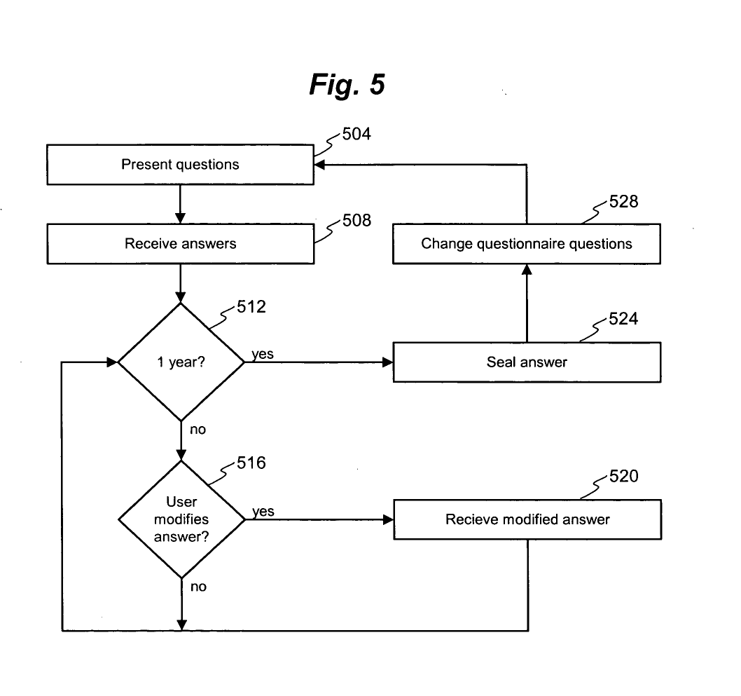

FIG. 5 is a flow diagram illustrating how a sealed yearly questionnaire may be presented, modified, and sealed according to an embodiment of the invention. At a step 504, one or more questions may be presented on a client device to a user. The questions may be stored on a journal server and transmitted to the client device for display. Each question may allow a multiple choice answer, a typed answer, or both. The user may be allowed to enter a short explanation of his or her answer as well. It is contemplated that the answer may come in the form of an image such as a handwritten answer or in the form of a video or audio recording.

The questions will generally be focused on aspects of the user's life such as his or her spiritual, professional, or home life. Questions may also be focused on the user's marriage, opinions, thoughts, and beliefs. To illustrate, some of the questions regarding the user's marriage may inquire about how a user proposed to his or her spouse and how the user felt at the time, the courtship prior to the marriage, how long the user dated his or her spouse prior to getting engaged, and when and where the user got married.

The user's answers will be transmitted by the client device and received by a journal server at a step 508. Once received, the answers may be stored on a storage device or memory device of the journal server. In one or more embodiments, each answer is stored such that it is associated with the question to which the answer was given. For example, an answer may be stored along with a copy of the question or the answer may be stored with an identifier which identifies the question asked.

At a decision step 512 the multimedia journal system determines if the period of a year has passed. As will be described further below, the user's answers may be sealed at the end of the period of a year in order to preserve the user's thoughts, opinions, and ideas for that year. Though generally described according to a yearly period, any other period of time may be used including but not limited to monthly, quarterly, and bimonthly periods. In addition, the beginning of the period of time before sealing may be determined in various ways. In one embodiment, the period of time may begin on the first day of the year. In another embodiment, the period of time may begin once a question has been answered. Of course, a user's answers may be sealed at a predetermined date, time, or both in some embodiments.

If a year has passed, at a step 524 the multimedia journal system may seal the answers the user has given in one or more embodiments. Sealing may occur by inputting the user's answers into a hashing algorithm to generate an answer hash key. Similar to sealing an entry, a predetermined code or other input may be inputted along with the user's answers to verify that the hash key has not been forged. It is contemplated that timestamps representing the time the answer was given, modified, or both may be inputted as well. Individual answers or groups of answers may be sealed in some embodiments. The answer hash key may then be associated with its corresponding answer or answers as described above.

Generally, sealing the answers represents the end of a period and thus a new period may begin by presenting the questionnaire to the user again to collect new answers. In one or more embodiments, it is contemplated that at a step 528 the questionnaire may be modified such as by adding, removing, or modifying questions. This may occur prior to the presentation of questions at step 504 for a new period of time. It is noted that, though possible, removing or modifying questions may not be desirable in some embodiments because these modifications prevent users from tracking their answers to the same questions over time.

Changes to the questionnaire may be suggested or made by administrators or personnel of the multimedia journal system, the user community, people with access to the user's journal (e.g. journal and access account holders), the users themselves, or a combination thereof. It is contemplated that in one or more embodiments changes to the questionnaire may require approval by the user before they are implemented. Also, changes to the questionnaire may be suggested by the system's account holders or others and voted on by the users, other account holders, or both for approval. Of course, some embodiments of the system may not allow the questionnaire to be modified.

If a year has not passed, at a decision step 516 the user may modify one or more answers. If so desired, the user may modify one or more answers at a step 520. The user may change any aspect of an answer at step 520 such as by selecting a different multiple choice answer or adding, removing, replacing, or changing previously entered, text, images, audio, video, or a combination thereof. The modifications may be transmitted to a journal server for storage.

After the modification has been transmitted, the multimedia journal system returns to decision step 512 where it is determined whether or not sufficient time has passed to seal the questionnaire's answers. If the user does not wish to modify any answers at decision step 516, the system also returns to decision step 512. Thus, it can be seen that the user may modify his or her answers at any time within the yearly time period. Of course, other time periods may be used as well, as stated above.

FIG. 6 is a flow diagram illustrating the display of one or more answers to one or more questions of the sealed yearly questionnaire according to an embodiment of the invention. At a step 604, a display request is received by a journal server. The display request may indicate to the journal server that the user wishes to view his or her questionnaire answers. At a step 608, the multimedia journal system may allow the user to specify the period of time of the answers he or she wishes to view. At a step 612, the system may allow the user to specify which questions to which he or she is interested in viewing the answers. Of course, some embodiments may allow either or both of the selections of step 608 and the selections of step 612. Other embodiments may not allow these selections at all.

At a step 616, the answers are retrieved by the multimedia journal system such as by retrieving the answers from one or more storage devices. If the user has made selections at step 608, step 612, or both, these selections may be used to identify which answers should be retrieved. At a step 620, an answer verification hash key may be generated for the retrieved answers. The answer verification hash key is compared to the answer hash key used to seal the answers to verify that the answers have not been modified since they were sealed. It is contemplated that each answer retrieved or groups of answers may be verified in this manner in one or more embodiments.

At a decision step 624 it is determined whether the two hash keys are identical in order to verify retrieved answers. If so, the multimedia journal system may display the retrieved answers at a step 628. If not, the system may proceed to step 632 and generate an error message. It is contemplated that the system may also display answers at step 632 with an indicator that indicates the one or more of the displayed answers has been modified. For example, modified answers may be displayed associated with a broken seal or other notification image. The system may display an indicator that indicates an intact seal of the hash keys match.

In one or more embodiments, the multimedia journal system may be searchable. For example, a screen may be provided where a user may enter in search terms. The search terms may then be used to find entries or other journal data matching or similar to the search terms. Matching results may then be displayed for the user. In addition, it is contemplated that users may tag certain types of journal data such as images, video, audio, writings, and drawings. Tagging may occur by allowing a user to enter text describing the journal data such as a caption. In addition, a user may tag portions of the journal data. For example, the user may highlight or select portions of an image and tag each portion by entering text which describes the portion of the image. Portions of audio, video, and other journal data may be similarly tagged as well. In this way users may search for non-textual information by searching for their tags. Of course, textual information may be tagged as well in some embodiments, if desired.

As stated, the multimedia journal system may be implemented in a variety of ways. In fact, it is contemplated that any combination of software (e.g. machine readable code), journal servers, and client devices capable of performing the functions described herein may be used. For example, the system may be implemented by a client software application running on one or more client devices which access a journal and the parts thereof from one or more journal servers running server software configured to communicate with the client application or applications. The client software may be configured to receive input from the user such as entries, footnotes, afterthoughts, and questionnaire answers as well as other information including but not limited to access information, account information, and user settings or preferences. This information may be communicated to the server software on one or more journal servers which stores the information such that it may be later retrieved by the client software.

In one or more embodiments, the multimedia journal system may be web or internet based. In these embodiments, web browser software on a client device communicates with web server software on one or more journal servers to present journals to users and to receive input from users. Generally, the web server software retrieves journal data from one or more databases and communicates such information to a web browser along with code or instructions on how the information should be formatted. As is known in the art, various scripting languages, such as but not limited to PHP, JavaScript, and ASP may be executed on either the journal server or the client device to implement the system. It is noted that scripting languages now known and later developed may also be used. In addition various combinations of scripting/programming languages, databases, markup languages, and other software servers may be used. For example, a combination of JavaScript, XML, PHP, and various web servers may be used to increase the interactivity of the journal such as in an AJAX implementation.

In one exemplary web based embodiment, the one or more journal servers run web server software and database software. In this embodiment, the web server software communicates with one or more web browsers running on one or more client devices. The journal data received by the web server software from user input collected by the web browsers may be stored in one or more databases on the journal server. For example, a new entry may be transmitted from a client device to a journal server. At the journal server, the entry may be received by the web server software which subsequently saves the information comprising the entry to a database. When a user wishes to view an entry (or other journal data), the web server software may retrieve the saved information from the database and transmit the information along with formatting instructions to the user's web browser. This may occur by the web server sending a web page in HTML format to one or more web browsers.

Sealing and verifying entries and questionnaire answers may occur by one or more scripts comprising instructions to seal and verify entries and questionnaire answers as described herein. The one or more scripts or programs may executed by the web server software or by other software on the journal server. For example, the web server software may be configured to execute a PHP, CGI, or other script to seal and verify entries and questionnaire answers. In addition, a background process such as cron may be used to seal and verify entries periodically by executing appropriate sealing and verifying software or scripts. Similarly, other functions of the multimedia journal system are performed by the web server and database software as well as one or more scripts or programs. The operation and interaction of web server software, database software, client and server side scripts is known in the art and is not extensively described so as to not obscure then invention.

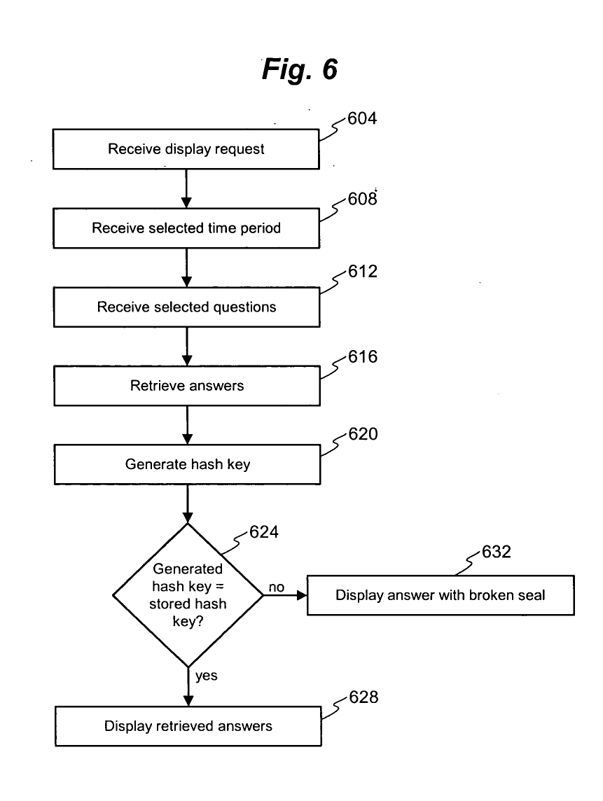

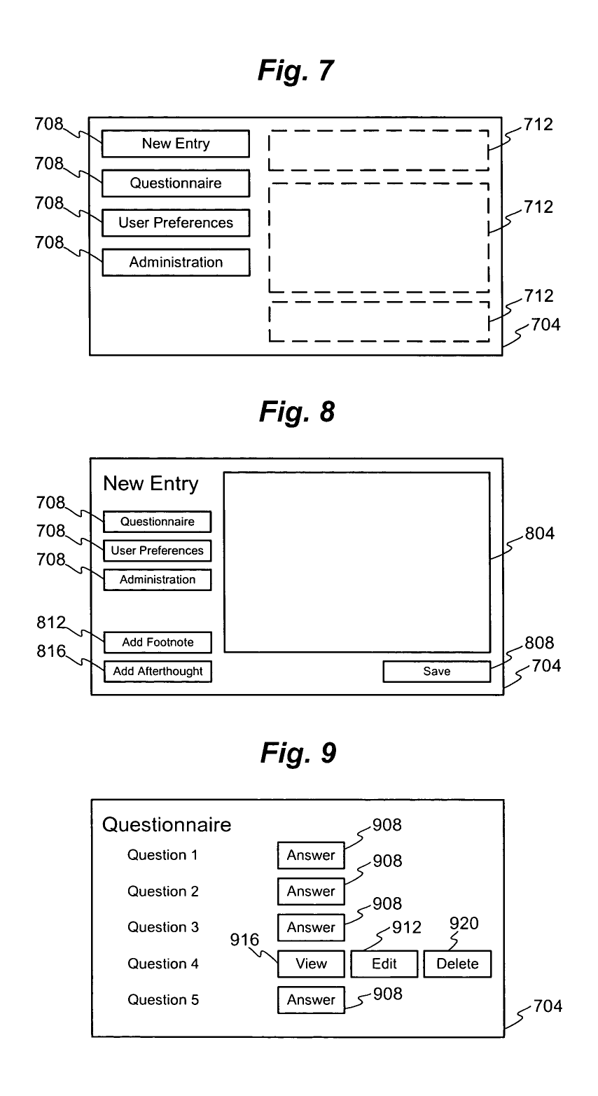

FIG. 7 shows an example embodiment of a menu that may be presented to the user in one or more web embodiments. FIG. 7 illustrates several menu options 708 which a user may select and several screen areas 712 which display journal data as displayed on a screen 704. The options shown are New Entry, Questionnaire, User Preferences, and Administration, each corresponding to the web screen or screens the user will be taken to if the option is selected. The screen areas 712 may display various types of information. For example, one or more screen areas 712 may display advertising, journal entries or other information, calendars, reminders, dates, and messages. In one or more embodiments, journal data, such as entries, comments, afterthoughts, footnotes, and questionnaires and their corresponding answers will typically be displayed. Of course, as is well known in the art, any type of information may be displayed. In addition, it is contemplated that audio may be played along with the visual information displayed on the screen 704.

FIG. 8 shows an example embodiment of a new entry screen. The new entry screen may include one or more input boxes 804 and a save button 808 or link. The input box 804 generally allows user input. As shown, the input box 804 is configured to collect input comprising a new entry. Of course other journal data, such as but not limited to afterthoughts, footnotes, questionnaire answers, or user settings may be collected. The input box 804 may allow text, video, or sound input. For example, the input box may display a cursor for text input, or may display audio/video playback controls to record audio/video input. In one embodiment, the input box 804 may display video as it is recorded and display recorded video as it is played back. In addition, the input box 804 may allow a user to upload a file such as by inputting the filename and path of the file, or the input box may be a checkbox such as for a multiple choice answer to a question. Once the desired input or inputs have been made, the user may save the entry by clicking or selecting the save button 808 which transmits the input to one or more journal servers for storage.

The new entry screen also shows a footnote button 812 and an afterthought button 816. Though not necessary in every embodiment, the footnote button 812 and afterthought button 816, once activated, may present the user with one or more additional input boxes 804 to allow the user to input a footnote or afterthought, respectively.

FIG. 9 shows an example embodiment of a questionnaire screen. As illustrated, the questionnaire screen displays a list of answered and unanswered questions of the sealed yearly questionnaire described above. Generally, each question will have an answer button 908 associated therewith which, when activated, may present the user with one or more input boxes to allow a user to input his or her answer to the question. For questions that have already been answered an edit button 912, view button 916, or delete button 920 may be displayed. These buttons, once activated, may present and input box with the existing answer and allow the user to edit such answer, may present the existing answer, or may delete the existing answer, respectively.

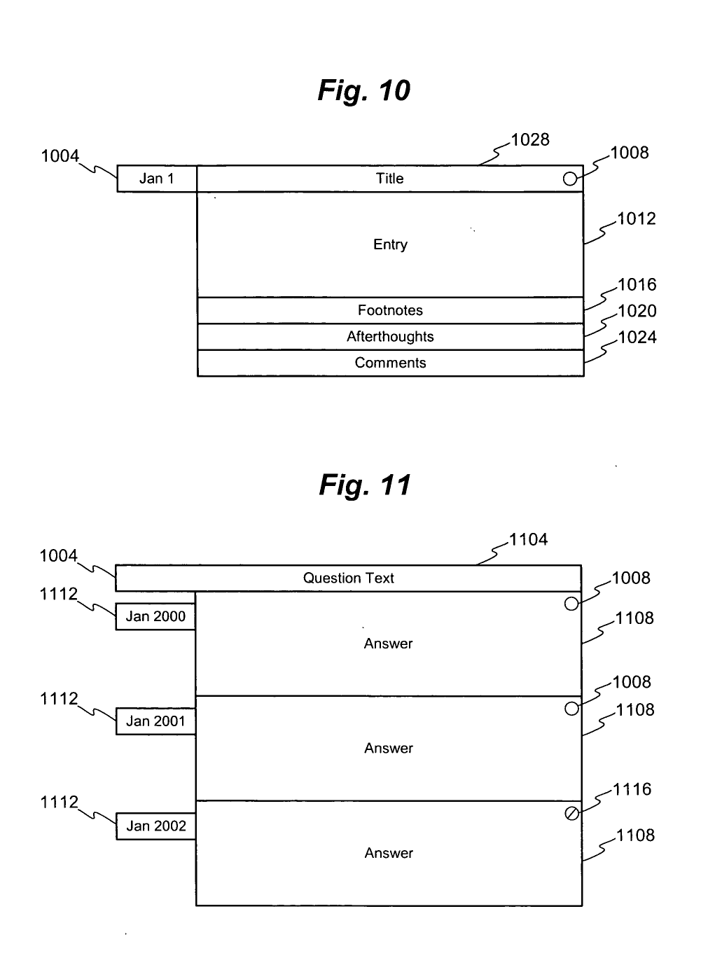

FIG. 10 shows an example of how a journal entry may be displayed. As illustrated, a journal entry 1012 is displayed with its creation date 1004, its title 1028 if any, and any footnotes 1016, afterthoughts 1020, or comments 1024 associated therewith. A seal 1008 in the form of an image may be displayed to indicate whether the entry has been sealed. FIG. 11 shows an example of how answers to the sealed yearly questionnaire may be displayed. As illustrated the question test 1104 is displayed along with an ordered list of every answer 1108 given to the question text 1104 and the date 1112 the answer 1108 was made. A seal 1008 in the form of a graphic may also be used to indicate whether an answer has been sealed. FIG. 11 also illustrates a broken seal 1116 which may be displayed when an entry or answer has been modified or tampered with after it has been sealed.

Though generally described as a web embodiment, it is noted that non-web embodiments may have similar characteristics, layouts, and features. In addition, the screens described above with regard to FIGS. 7-11 are but one embodiment. Various layouts and formats may be used to present the journal and the parts thereof to users as well as to collect input from users. In fact, it is contemplated that users may be able to customize the look, such as the page layout, formatting, fonts, colors, and images, of the user's journal. Such customization may be implemented through use of existing technology, such as CSS, or be implemented by scripting or programming with languages and techniques now known or later developed. Finally, it is noted that FIGS. 10-11 also illustrate an example of how a journal entries or questionnaire answers may appear on a screen when accessed from a copy published to removable media, or when viewed from a copy published to a book or on paper.

While various embodiments of the invention have been described, it will be apparent to those of ordinary skill in the art that many more embodiments and implementations are possible that are within the scope of this invention. In addition, the various features, elements, and embodiments described herein may be claimed or combined in any combination or arrangement.

What is claimed is:

1. A journal system comprising:
one or more journal servers comprising:
one or more storage devices;
one or more processors; and
at least one network interface;
a journal stored on the one or more storage devices comprising:
one or more journal entries; and
one or more questionnaire answers;
wherein the one or more journal entries and one or more questionnaire answers are created by a user; and
machine readable code stored on the one or more storage devices comprising instructions to seal the one or more journal entries and the one or more questionnaire answers;
wherein the one or more journal servers are configured to receive the one or more journal entries and the one or more questionnaire answers from one or more client devices.

2. The journal system of claim 1 wherein the machine readable code seals the one or more journal entries after a 24 hour period.

3. The journal system of claim 1 wherein the machine readable code comprises instructions to seal the one or more journal entries by generating a first hash key from an input comprising at least the one or more journal entries.

4. The journal system of claim 3 wherein the machine readable code further comprises instructions to display one or more indicators with one or more retrieved journal entries on the one or more client devices if a second hash key generated from an input comprising at least the one or more retrieved journal entries is not identical to the first hash key, the one or more indicators indicating one or more of the one or more retrieved journal entries have broken seals.

5. The journal system of claim 1 wherein the machine readable code seals the one or more questionnaire answers yearly.

6. The journal system of claim 1 wherein the machine readable code comprises instructions to seal the one or more questionnaire answers by generating a first hash key from an input comprising at least the one or more questionnaire answers.

7. The journal system of claim 6 wherein the machine readable code further comprises instructions to display one or more indicators with one or more retrieved questionnaire answers on the one or more client devices if a second hash key generated from an input comprising at least the one or more retrieved questionnaire answers is not identical to the first hash key, the one or more indicators indicating one or more of the one or more retrieved questionnaire answers have broken seals.

8. The journal system of claim 1 wherein the machine readable code further comprises instructions to accept information identifying one or more journal stewards and to grant the one or more journal stewards stewardship access to the one or more journals upon the death of the user.

9. The journal system of claim 1 wherein the machine readable code further comprises instructions to archive the journal for an archival period, the archival period beginning after the death of the user.

10. The journal system of claim 1 wherein the machine readable code further comprises instructions to selectively share access to the one or more journal entries with one or more other journal accounts or one or more access accounts.

11. The journal system of claim 10 wherein the journal further comprises one or more comments associated with at least one of the one or more journal entries, the one or more comments created with the one or more journal accounts or the one or more access accounts.

12. The journal system of claim 1 wherein the journal further comprises one or more afterthoughts created by the user and associated with at least one of the one or more journal entries.

13. The journal system of claim 1 wherein the journal further comprises one or more footnotes created by the user and associated with at least one of the one or more journal entries.

14. The journal system of claim 1 further comprising one or more copies of the journal published to a removable media.

15. A journal system comprising:
one or more journal servers in communication with one or more client devices, the one or more journal servers comprising one or more storage devices, one or more processors, and at least one network interface;
a journal stored on the one or more storage devices, the journal comprising one or more journal entries and one or more questionnaire answers; and
machine readable code stored on the one or more storage devices comprising:
instructions to seal the one or more journal entries by generating a entry hash key from at least the one or more journal entries after a predetermined period of time;
instructions to seal the one or more questionnaire answers by generating a answer hash key from at least the one or more questionnaire answers after a predetermined period of time; and
instructions to selectively share the one or more journal entries, the one or more questionnaire answers, or both;
wherein the one or more journal servers receive the one or more journal entries and the one or more questionnaire answers from the one or more client devices.

16. The journal system of claim 15 wherein the instructions to seal the one or more journal entries generate an entry hash key from at least the one or more journal entries and an entry timestamp associated therewith, and the instructions to seal the one or more questionnaire answers generate an answer hash key from at least the one or more questionnaire answers and an answer timestamp associated therewith.

17. The journal system of claim 15 wherein the machine readable code further comprises:
instructions to retrieve a requested journal entry from the one or more journal entries, and to verify the requested journal entry by generating an entry verification hash key from at least the requested journal entry and comparing the entry verification hash key to the entry hash key; and
instructions to retrieve a requested questionnaire answer from the one or more questionnaire answers, and to verify the requested questionnaire answer by generating an answer verification hash key from at least the requested questionnaire answer and comparing the answer verification hash key to the answer hash key.

18. The journal system of claim 17 wherein the one or more client devices displays a first indicator with the requested journal entry if the requested journal entry is verified, the first indicator indicating the requested journal entry has an intact seal.

19. The journal system of claim 17 wherein the one or more client devices displays a second indicator with the requested journal entry if the request journal entry is not verified, the second indicator indicating the requested journal entry has a broken seal.

20. The journal system of claim 17 wherein the one or more client devices displays a first indicator with the requested questionnaire answer if the requested questionnaire answer is verified, the first indicator indicating the requested questionnaire answer has an intact seal.

21. The journal system of claim 17 wherein the one or more client devices displays a second indicator with the requested questionnaire answer if the requested questionnaire answer is not verified, the second indicator indicating the requested questionnaire answer has a broken seal.

22. The journal system of claim 15 wherein the machine readable code further comprises instructions to accept information identifying one or more journal stewards and to grant the one or more stewards stewardship access to the journal upon the incapacitation of the user.

23. The journal system of claim 15 wherein the machine readable code further comprises instructions to archive the journal for an archival period upon the incapacitation of the user.

24. The journal system of claim 15 wherein copies of the journal are stored on two or more journal servers.

25. The journal system of claim 15 wherein the journal further comprises one or more comments associated with at least one of the one or more journal entries, the one or more comments created with one or more journal accounts or one or more access accounts.

26. The journal system of claim 15 wherein the journal further comprises one or more afterthoughts created by the user and associated with at least one of the one or more journal entries.

27. The journal system of claim 15 wherein the journal further comprises one or more footnotes created by the user and associated with at least one of the one or more journal entries.

28. The journal system of claim 15 further comprising one or more copies of the journal published to a removable media.

29. A method for providing a journal comprising:
receiving one or more journal entries from a user at one or more client devices;
presenting one or more questionnaire questions and receiving one or more questionnaire answers from the user at the one or more client devices;
storing the one or more journal entries, the one or more questionnaire answers, or both on one or more storage devices, the one or more storage devices attached to one or more journal servers; and
associating the one or more journal entries and the one or more questionnaire answers with a journal identifier, the journal identifier uniquely identifying a journal;
sealing the one or more journal entries, the one or more questionnaire answers, or both.

30. The method of claim 29 further comprising selectively sharing access to the one or more journal entries, the one or more questionnaire answers, or both with one or more journal accounts or one or more access accounts.

31. The method of claim 29 further comprising:
accepting information identifying one or more journal stewards; and
granting the one or more journal stewards stewardship access to the journal upon the death of the user.

32. The method of claim 29 further comprising publishing the journal to removable media.

33. The journal system of claim 29 wherein copies of the journal are stored on a two or more journal servers.

34. The journal system of claim 29 wherein the journal further comprises one or more comments associated with at least one of the one or more journal entries, the one or more comments created with one or more journal accounts or one or more access accounts.

35. The journal system of claim 29 wherein the journal further comprises one or more afterthoughts created by the user and associated with at least one of the one or more journal entries.

36. The journal system of claim 29 wherein the journal further comprises one or more footnotes created by the user and associated with at least one of the one or more journal entries.
